(19) United States
(12) Patent Application Publication
(10) Pub. No.: US 2013/0217579 A1
(43) Pub. Date: Aug. 22, 2013

(54) Pesticide Preparations Containing N-Substituted 2-Pyrrolidone-4-Carboxylic Acid Esters

(71) Applicants: Andreas Wacker, Mannheim (DE); Joachim Hess, Hofheim (DE); Rainer Kupfer, Hattersheim (DE); Alexander Roesch, Oppenheim (DE)

(72) Inventors: Andreas Wacker, Mannheim (DE); Joachim Hess, Hofheim (DE); Rainer Kupfer, Hattersheim (DE); Alexander Roesch, Oppenheim (DE)

(73) Assignee: CLARIANT FINANCE (BVI) LIMITED, Tortola (VG)

(21) Appl. No.: 13/822,970

(22) PCT Filed: Sep. 14, 2011
(86) PCT No.: PCT/EP11/04614

§ 371 Date: Mar. 27, 2013

(30) Foreign Application Priority Data
Sep. 16, 2010 (DE) 10 2010 046 679.4

(51) Int. Cl. A01N 25/02

(52) U.S. Cl. CPC A01N 25/02
USPC 504/347; 514/383; 514/539

(57) ABSTRACT

Disclosed are pesticide preparations containing a) one or more pesticides and b) one or more N-substituted 2-pyrrolidone-4-carbonic acid esters of formula (1), where R1 and R2 independently represent linear, branched, or cyclic C1-C6 alkyl.

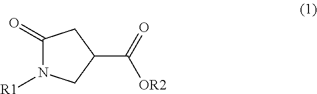

The invention relates to pesticide preparations comprising certain N-substituted pyrrolidonecarboxylic acid esters and to the use thereof for controlling and/or combating weeds, fungal diseases or insect infestation. The N-substituted pyrrolidonecarboxylic acid esters act in particular as solvents in the pesticide preparations.

The suitability of a substance as solvent is essentially determined by its physicochemical properties. In the case of a solvent for pesticide preparations, these are e.g. setting point and boiling point, flash point, viscosity, polarity, inertness, dissolving capacity, miscibility with water and other solvents.

A large number of solvents is traditionally used in pesticide preparations, including polar solvents such as cyclohexanone, tetrahydrofurfuryl alcohol (THFA), isophorone, gamma-butyrolactone or N-methylpyrrolidone (NMP). However, the stated solvents have the disadvantage that they no longer satisfy the current requirements placed on an environmentally friendly solvent, such as high flash point, low VOC content, being based on renewable raw materials, or toxicological or ecotoxicological properties.

It was therefore an object of the present invention to provide pesticide preparations comprising solvents, where the solvents avoid, at least partially or even completely, one or more and preferably all of the aforementioned disadvantages, and are advantageous in particular from environmental points of view and have favorable solvent properties, especially for pesticides.

Surprisingly, it has now been found that this object is achieved by certain N-substituted pyrrolidonecarboxylic acid esters.

The invention therefore provides pesticide preparations comprising

a) one or more pesticides and

b) one or more N-substituted 2-pyrrolidone-4-carboxylic acid esters of the formula (1)

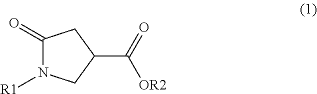

in which
R1 and R2 independently of one another are a linear, branched or cyclic C₁-C₆-alkyl.

Preferably, R1 and R2 in the compounds of the formula (1) are, independently of one another, linear or branched C₁-C₆-alkyl.

Particularly preferably, R1 and R2 in the compounds of the formula (1) are, independently of one another, methyl, ethyl, n-propyl, isopropyl, n-butyl or isobutyl.

Particularly preferably, in the compounds of the formula (1),

R1 and R2 are methyl or

R1 is methyl and R2 is isobutyl or

R1 is n-butyl and R2 is methyl or

R1 is isobutyl and R2 is methyl.

In the pesticide preparations according to the invention, the one or more compounds of the formula (1) act in particular as solvents for the one or more pesticides likewise present therein.

The preparation of the compounds of the formula (1) is possible for example by reaction of itaconic acid with alkylamines and subsequent esterification or by direct reaction of itaconic acid esters with alkylamines and is described in the literature (Wu; Feldkamp; Journal of Organic Chemistry; vol. 26; (1961); p. 1519 or Arvanitis, Motevalli, Wyatt, Tetrahedron Lett. 1996, 37, 4277-4280).

DE 24 52 536 describes N-alkylpyrrolidone derivatives synthesized via a plurality of stages and the use thereof as pharmaceutical active ingredients. Various short-chain N-alkyl-2-pyrrolidone-4-carboxylic acid esters are formed here as intermediates in the synthesis of these active ingredients.

EP 1 342 759 discloses an ink-jet ink which, besides water, comprises a water-soluble ester or amide of pyrrolidone-2-carboxylic acid substituted at different points of the heterocyclic ring, the pyrrolidonecarboxylic acid derivative serving to improve the printing quality.

EP 2 028 247 describes the use of N-alkyl-2-pyrrolidone-4-carboxylic acid esters as gas hydrate inhibitors.

WO 2010/033447 discloses the use of various heterocycles, including N-alkyl-2-pyrrolidone-4-carboxylic acid esters as EP/AW additive in lubricants.

EP 2 193 782 and EP 2 193 784 disclose cosmetic preparations which comprise a UV absorber and an N-alkylpyrrolidonecarboxylic acid ester.

DE 10 2009 043 122.5 describes long-chain (R1>C7) representatives of the N-alkyl-2-pyrrolidone-4-carboxylic acid, including their esters and their use in crop protection formulations, for example as adjuvant or emulsifier. The use of short-chain derivatives is not described therein.

In contrast to long-chain alkylpyrrolidonecarboxylic acid esters (see formula (1) but where R1>C7), which are obtained by reaction of relatively long-chain alkylamines or fatty amines (R1>C7), N-alkyl-2-pyrrolidone-4-carboxylic acid esters prepared on the basis of short-chain amines (R1<C7) are characterized by a higher polarity and solubility in water. This applies particularly if the alkyl group of the ester function is likewise short-chain (R2<C7).

Moreover, the compounds of the formula (1) have further advantageous physicochemical properties. By virtue of their low setting point of considerably lower than 0° C., they can also be used as solvents at low temperatures without solidifying. This is advantageous for example in the winter or cold regions both during use and also during storage. The high boiling point brings about a low vapor pressure and a high flash point (typically >100° C.), meaning that safety-related advantages also support the use of these solvents. A further important requirement placed on environmentally friendly solvents nowadays is a low content of volatile organic compounds (Volatile Organic Solvents, VOC), which is met by the compounds of the formula (1). An established method of determining the VOC content is a gas chromatographic analysis in accordance with DIN EN ISO 11890-2. Preferably, the VOC content of the compounds of the formula (1) in accordance with DIN EN ISO 11890-2 is less than 5% by weight, particularly preferably less than 1% by weight and especially preferably less than 0.5% by weight.

The compounds of the formula (1) are expediently prepared from itaconic acid or derivatives thereof. Itaconic acid is obtained on an industrial scale from sugar and, according to the study of the same name ordered by the US Department of Energy from 2004, counts among the “Top Value Added Chemical From Biomass” (http://wwvv.nrel.gov/docs/fy04osti/35523.pdf). The compounds of the formula (1) derived therefrom can therefore be prepared in an environmentally friendly manner on the basis of renewable raw materials.

Pesticides are usually used in the form of preparations in order to achieve a better utilization of the active ingredients. Such preparations are also referred to as formulations and are generally present in solid or liquid form.

Liquid preparations comprise solvents, which can take on a variety of tasks—in the simplest case water. Examples of liquid preparations (“formulation types”) are pesticide solutions in a solvent (SL), suspension concentrates (SC), suspoemulsions (SE), emulsifiable concentrates (EC), oil dispersions (OD), emulsions in water (EW) or microemulsions (ME).

Many solvents which are usually used in pesticide preparations are unacceptable from a toxicological or ecotoxicological point of view, such as aromatic hydrocarbons, gamma-butyrolactone, isophorone or NMP.

In the case of liquid pesticide preparations, a distinction can be made whether the pesticide is dissolved in the solvent or is present as a solid in dispersed form. Examples in which the pesticide is present dissolved in the solvent are primarily SL, EC, EW, SE and ME formulations. Here, besides a pesticide dissolved in the solvent, it is also possible for a further pesticide to be present in the formulation which, on account of its physicochemical properties, is insoluble in the solvent and is therefore present separate from the first in dispersed form or dissolved in a further solvent of different polarity. Examples of such formulations are EWs in which a (water-soluble) pesticide is present dissolved in the aqueous phase and a second (water-insoluble) pesticide is present dissolved in the non-aqueous solvent phase. Another example is an SE formulation in which a pesticide is present in dispersed form in the aqueous phase and a second pesticide is dissolved in the non-aqueous solvent phase.

Preferably, the pesticide preparations according to the invention are emulsifiable concentrates (EC), emulsions in water (EW), soluble liquids (SL), microemulsions (ME), suspoemulsions (SE), suspension concentrates (SC) or oil dispersions (OD).

Pesticide preparations in which the pesticides are present dissolved in a solvent (for example in SL, EC, EW or ME preparations), have the advantage that the pesticides are present therein in a very homogeneously distributed form. As a result, a very uniform distribution of the pesticides on the plant or the harmful organism is possible and a relatively rapid uptake of the pesticides is ensured on account of the high mobilities. By contrast, if the pesticides are present in the preparations in a solid, undissolved form (for example in SC, OD or SE pesticide preparations), the pesticides are in a significantly less homogeneously distributed form and, prior to uptake into the plant or the harmful organism, have to first be brought into solution from the undissolved particles. Consequently, pesticide preparations which comprise pesticides in dissolved form are often characterized by higher efficacy.

In a particularly preferred embodiment of the invention, the pesticide preparations according to the invention are emulsifiable concentrates (EC).

In a further particularly preferred embodiment of the invention, the pesticide preparations according to the invention are emulsions in water (EW).

In most cases, the solvents present in the formulations serve to provide the pesticides in dissolved form. However, they can also perform other tasks, such as, for example, serving as antifreeze in aqueous preparations or as cosolvent or crystallization inhibitor in order to prevent the pesticides from crystallizing out either in the formulations or following dilution of the formulations in the aqueous spray mixtures.

Preference is therefore given to pesticide preparations according to the invention in which the one or more compounds of the formula (1) act as crystallization inhibitor.

The invention therefore also further provides the use of one or more compounds of the formula (1) as crystallization inhibitor.

The crystallization-inhibiting effect can be demonstrated for example by storing the pesticide preparations in accordance with the corresponding CIPAC methods. A further option is to demonstrate the crystallization-inhibiting effect in the preparations already diluted with water, which correspond to the spray mixtures.

On account of the low solubilities which particularly modern pesticides have in water and most solvents, the selection of suitable solvents for pesticide preparations is very limited. Preparations in which these pesticides are present in dissolved form can therefore often not be prepared or possibly only in solvents which are actually to be avoided from toxicological or ecotoxicological points of view, such as user's safety or environmental protection, such as, for example, NMP.

Suitable new solvents in pesticide preparations must therefore have extremely high solubilities for pesticides that have poor solubility in water or other solvents. A very high solubility of the pesticides in the solvents is desired in order to achieve a high loading of the formulations with active ingredient, a very good stability and a low crystallization tendency of the active ingredients.

Furthermore, preference is therefore given to pesticide preparations according to the invention in which the solubility of the one or more pesticides of component a) in water at 20° C. is less than 1000 mg/l, particularly preferably less than 500 mg/l and especially preferably less than 100 mg/l.

Furthermore, preference is given to pesticide preparations according to the invention in which the solubility of the one or more pesticides of component a) in the one or more compounds of formula (1) at 20° C. is at least 10 g/l, particularly preferably at least 50 g/l and especially preferably at least 100 g/l.

Within the context of the present invention, “pesticides” are understood as meaning herbicides, fungicides, insecticides, acaricides, bactericides, molluscides, nematicides and rodenticides and also phytohormones. Phytohormones control physiological reactions, such as growth, flowering rhythm, cell division and seed ripening. An overview of the most relevant pesticides can be found for example in “The Pesticide Manual” from the British Crop Protection Council, 14th Edition 2006, Editor: C D S Tomlin.

The one or more pesticides of component a) of the pesticide preparations according to the invention are preferably selected from the group consisting of herbicides, insecticides and fungicides.

Preferred fungicides are aliphatic nitrogen fungicides, amide fungicides such as acylamino acid fungicides or anilide fungicides or benzamide fungicides or strobilurin fungicides, aromatic fungicides, benzimidazole fungicides, benzothiazole fungicides, carbamate fungicides, conazole fungicides such as imidazoles or triazoles, dicarboximide fungicides, dithiocarbamate fungicides, imidazole fungicides, morpholine fungicides, oxazole fungicides, pyrazole fungicides, pyridine fungicides, pyrimidine fungicides, pyrrole fungicides, quinone fungicides.

Preferred herbicides are amide herbicides, anilide herbicides, aromatic acid herbicides such as benzoic acid herbicides or picolinic acid herbicides, benzoylcyclohexanedione herbicides, benzofuranylalkylsulfonate herbicides, benzothiazole herbicides, carbamate herbicides, carbanilate herbicides, cyclohexene oxime herbicides, cyclopropylisoxazole herbicides, dicarboximide herbicides, dinitroaniline herbicides, dinitrophenol herbicides, diphenyl ether herbicides, dithiocarbamate herbicides, imidazolinone herbicides, nitrile herbicides, organophosphorus herbicides, oxadiazolone herbicides, oxazole herbicides, phenoxy herbicides such as phenoxyacetic acid herbicides or phenoxybutanoic acid herbicides or phenoxypropionic acid herbicides or aryloxyphenoxypropionic acid herbicides, pyrazole herbicides such as benzoylpyrazole herbicides or phenylpyrazole herbicides, pyridazinone herbicides, pyridine herbicides, thiocarbamate herbicides, triazine herbicides, triazinone herbicides, triazole herbicides, triazolone herbicides, triazolopyrimidine herbicides, uracil herbicides, urea herbicides such as phenylurea herbicides or sulfonylurea herbicides.

Preferred insecticides are carbamate insecticides, such as benzofuranyl methylcarbamate insecticides or dimethylcarbamate insecticides or oxime carbamate insecticides or phenyl methylcarbamate insecticides, diamidine insecticides, insect growth regulators, macrocyclic lactone insecticides such as avermectin insecticides or milbemycin insecticides or spinosyn insecticides, nereistoxin analogous insecticides, nicotinoid insecticides such as nitroguanidine nicotinoid insecticides or pyridylmethylamine nicotinoid insecticides, organophosphorus insecticides such as organophosphate insecticides or organothiophosphate insecticides or phosphonate insecticides or phosphoramidothioate insecticides, oxadiazine insecticides, pyrazole insecticides, pyrethroid insecticides such as pyrethroid ester insecticides or pyrethroid ether insecticides or pyrethroid oxime insecticides, tetramic acid insecticides, tetrahydrofurandione insecticides, thiazole insecticides.

An overview of the pesticides and their classification into the corresponding pesticide classes can be found for example in “The Pesticide Manual” of the British Crop Protection Council, 14th Edition 2006, Editor: C D S Tomlin.

Particularly preferably, the one or more pesticides of component a) of the pesticide preparations according to the invention is or are selected from the group consisting of aryloxyphenoxypropionic acid herbicides, benzoylcyclohexanedione herbicides, triazolopyrimidine herbicides, strobilurin fungicides, triazole fungicides, nicotinoid insecticides and pyrethroid insecticides.

Particularly preferably, the one or more pesticides of component a) of the pesticide preparations according to the invention is or are selected from the group consisting of trifloxystrobin, tebuconazole, pendimethalin, triadimefon and trifluralin.

The preparation of the pesticide preparations according to the invention is possible in different ways, depending on the type of formulation, and is sufficiently known to the person skilled in the art.

The pesticide preparations according to the invention comprise the one or more pesticides of component a) in amounts of preferably 0.1 to 75% by weight, particularly preferably from 5 to 50% by weight and especially preferably from 10 to 40% by weight. This quantitative data is based on the total weight of the pesticide preparations according to the invention.

Furthermore, the pesticide preparations according to the invention comprise the one or more compounds of the formula (1) preferably in amounts of from 0.1 to 99% by weight, particularly preferably from 5 to 75% by weight and especially preferably from 10 to 50% by weight. This quantitative data is based on the total weight of the pesticide preparations according to the invention.

The pesticide preparations according to the invention are preferably applied to the fields in the form of spray mixtures. In this connection, a spray mixture is prepared by diluting the concentrate formulation with a defined amount of water.

The pesticide preparations according to the invention can also be present in the form of spray mixtures and comprise preferably from 0.001 to 10% by weight, particularly preferably from 0.02 to 3% by weight and especially preferably from 0.025 to 2% by weight of the one or more pesticides of component a) and preferably from 0.001 to 10% by weight, particularly preferably from 0.02 to 3% by weight and especially preferably from 0.025 to 2% by weight, of one or more compounds of the formula (1). This quantitative data is based on the total weight of the spray mixture.

The weight ratio of the one or more compounds of the formula (1) to the one or more pesticides of component a) in the spray mixture is preferably from 1:10 to 10:1 and particularly preferably from 1:4 to 4:1.

Per hectare, pesticide amounts are preferably applied in the range from 0.005 to 5 kg. The fraction of the one or more compounds of the formula (1) is in the range from preferably 0.005 to 5 kg/ha. The volume of the spray mixture prepared for the application is preferably in the range from 50 to 1000 l/ha.

Here, the one or more pesticides of component a) and the one or more compounds of the formula (1) can also be present in the form of a so-called “tank-mix” preparation. In a preparation of this type, both the one or more pesticides of component a) and also the one or more compounds of the formula (1) are firstly separate from one another. The two preparations are mixed together prior to application, as a rule shortly beforehand, giving a preparation according to the invention. Such a procedure is useful for example if the one or more compounds of the formula (1) are to serve as crystallization inhibitors.

The pesticide preparations according to the invention can comprise one or more auxiliaries which assume a very wide variety of functions. Examples of auxiliaries according to their function are thickeners, additional solvents, dispersants, emulsifiers, preservatives, adjuvants, binders, thinners, disintegrants, wetting agents, penetration promoters, low-temperature stabilizers, colorants, antifoams, antioxidants, crystallization inhibitors, antifreezes or humectants.

In a preferred embodiment of the invention, the pesticide preparations according to the invention comprise at least one and preferably at least two auxiliaries besides the one or more pesticides of component a) and the one or more compounds of the formula (1).

Thickeners which can be used are all substances which can usually be used for this purpose in agrochemical formulations, such as xanthan gum and/or cellulose, for example carboxy-, methyl-, ethyl- or propylcellulose or (optionally modified) bentonite in the amounts of preferably 0.01 to 5% by weight, based on the total weight of the pesticide preparations according to the invention.

Suitable additional solvents are all substances which can customarily be used for this purpose in agrochemical formulations, such as, for example, aromatic and aliphatic hydrocarbons, acetophenone, lactic acid esters such as ethylhexyl lactate, esters of carbonic acid such as propylene carbonate, fatty acid amides such as N-dimethyldecanamide, esters of phosphorous acid or of phosphoric acid such as bis(ethylhexyl) ethylhexylphosphonate or tri(ethylhexyl) phosphate, glycols, polyethylene glycols, propylene glycol, natural and mineral oils, and also esters of fatty acids.

Suitable dispersants and emulsifiers are all substances which can usually be used for this purpose in agrochemical formulations, such as nonionic, amphoteric, cationic and anionic (polymeric) surfactants.

Preservatives which can be used are all substances that can customarily be used for this purpose in agrochemical formulations, such as organic acids and their esters, for example ascorbic acid, ascorbyl palmitate, sorbate, benzoic acid, methyl and propyl 4-hydroxybenzoate, propionates, phenol, for example 2-phenylphenate, 1,2-benzisothiazolin-3-one, formaldehyde, sulfurous acid and salts thereof.

Adjuvants are understood as meaning auxiliaries which increase the biological effectiveness of the active ingredients without themselves exhibiting a biological effect by, for example, improving the wetting, the retention or the takeup into the plant or the target organism. Adjuvants which can be used are all substances that can usually be used for this purpose in agrochemical formulations, such as optionally crosslinked polyglycerol esters, alcohol alkoxylates such as e.g. alcohol ethoxylates, alkylpolysaccharides, fatty amine ethoxylates, esters of phosphorous acid or of phosphoric acid, such as bis(ethylhexyl) ethylhexylphosphonate or tri(ethylhexyl) phosphate, sorbitan and sorbitol ethoxylate derivatives and derivatives of alk(en)ylsuccinic acid.

Suitable penetration promoters are all substances which are usually used in order to improve the penetration of pesticides into plants or into target organisms. Penetration promoters can be defined for example by the fact that they penetrate from the aqueous spray mixture and/or from a spray coating on the plant surface into the cuticle of the plant and as a result can increase the material mobility of active ingredients in the cuticle. The method described in the literature can be used for determining this property (Baur et al., 1997, Pesticide Science 51, 131-152).

Wetting agents which can be used are all substances which can usually be used for this purpose in agrochemical formulations, such as alcohol ethoxylates, alcohol alkoxylates, EO/PO block copolymers (EO: ethylene oxide unit; PO: propylene glycol unit) or optionally ethoxylated alkylsulfonic acids.

Substances which can act as low-temperature stabilizers are all those substances which can usually be used for this purpose in agrochemical formulations. By way of example, mention may be made of urea, glycerol and propylene glycol.

Suitable colorants are all substances that can customarily be used for this purpose in agrochemical formulations, such as water- or oil-soluble dyes, and also organic or inorganic pigments.

Suitable antifoams are all substances which can customarily be used for this purpose in agrochemical formulations, such as fatty acid alkyl ester alkoxylates; organopolysiloxanes such as polydimethylsiloxanes and mixtures thereof with microfine, optionally silanized silica;

perfluoroalkylphosphonates and phosphinates; paraffins; waxes and microcrystalline waxes and mixtures thereof with silanized silica. Mixtures of different foam inhibitors, for example those of silicone oil, paraffin oil and/or or waxes are also advantageous.

Suitable antioxidants are all substances that can customarily be used for this purpose in agrochemical formulations, such as, for example, BHT (2,6-dtert-butyl-4-methylphenol).

Moreover, the pesticide preparations according to the invention can comprise one or more agrochemical salts, preferably potassium or ammonium salts.

The pesticide preparations according to the invention are suitable in particular for controlling and/or combating weeds, fungal diseases or insect infestation.

The present invention therefore also further provides the use of a pesticide preparation according to the invention for controlling and/or combating weeds, fungal diseases or insect infestation.

### EXAMPLES

The invention is illustrated below by reference to examples, but these should in no way be considered to be a limitation.

The commercial products used are:

| | |
|---|---|
| Emulsogen ® EP 4901 | butanol-based EO/PO copolymer from Clariant |
| Emulsogen ® TS 160 | tristyrylphenol ethoxylate (16 EO) from |
| | Clariant |
| Emulsogen ® TS 200 | tristyrylphenol ethoxylate (20 EO) from |
| | Clariant |
| Dispersogen ® TP 160 | tristyrylphenol polyether phosphate (16 EO) |
| | from Clariant |
| Dispersogen ® LFH | tristyrylphenol polyether phosphate from |
| | Clariant |
| Phenylsulfonate CA | Ca dodecylbenzenesulfonate in isobutanol from |
| | Clariant |
| Emulsogen ® EL 360 | ethoxylated castor oil (36 EO) from Clariant |
| Emulsogen ® EL 400 | ethoxylated castor oil (40 EO) from Clariant |
| Synergen ® KN | fungicide adjuvant from Clariant |
| Solvesso ® 150 | aromatic hydrocarbons from Exxon |

### Example 1

### Preparation of methyl N-methyl-2-pyrrolidone-4-carboxylate

239.9 g of N-methyl-2-pyrrolidone-4-carboxylic acid are initially introduced into 410 g of dichloromethane. Then, at 50° C., 108.4 g of methanol and 9.6 g of p-toluenesulfonic acid are added and the mixture is stirred at reflux for 16 hours. When the reaction is complete, the reaction mixture is washed with water and sodium hydrogen carbonate solution, and the aqueous phases are extracted by shaking with chloroform and dried over magnesium sulfate. Filtration is then carried out, and the solvent is removed on a rotary evaporator and subjected to fractional distillation in vacuo. The product passes over at a temperature of 121-130° C. at 4 to 7 mbar. The resulting product has a saponification number of 360.0 mg KOH/g (theory: 356.9 mg KOH/g) and a water content of <0.1% by weight. This gives 106.0 g of methyl N-methyl-2-pyrrolidone-4-carboxylate.

### Example 2

### Preparation of isobutyl N-methyl-2-pyrrolidone-4-carboxylate

507.8 g of N-methyl-2-pyrrolidone-4-carboxylic acid, 203.8 g of isobutanol and 10.0 g of p-toluenesulfonic acid are initially introduced into 500 g of chloroform and the mixture is stirred at reflux under a nitrogen atmosphere for 31 hours, during which the resulting water of reaction is continuously distilled off. When the reaction is complete, washing is carried out with sodium hydrogen carbonate solution, and the aqueous phase is extracted by shaking with chloroform and dried over magnesium sulfate. Filtration is then carried out followed by concentration on a rotary evaporator and fractional distillation in vacuo. The product passes over at a temperature of 143-155° C. at 5 to 7 mbar. The resulting product has a saponification number of 282.8 mg KOH/g (theory: 281.6 mg KOH/g) and a water content of <0.1% by weight. This gives 394.5 g of isobutyl N-methyl-2-pyrrolidone-4-carboxylate.

### Example 3

### Preparation of N-butyl N-methyl-2-pyrrolidone-4-carboxylate

363.5 g of dibutyl itaconate (M =242.3 g/mol) are initially introduced and heated to 70° C. with stirring under a nitrogen atmosphere. Then, 119.3 g of methylamine (40% strength by weight in water, M=31.1 g/mol) are added dropwise over the course of 2 hours, during which an exothermic reaction is observed. The reaction mixture is then brought to reflux temperature (103° C.) and stirred at reflux for 3 hours. Then, the water present and the butanol formed is distilled off at 110 to 160° C. for 2.5 hours. The crude product is subjected to fractional distillation in vacuo. The product passes over at a temperature of 162-170° C. at 8 mbar. The resulting product has a saponification number of 282.4 mg KOH/g (theory: 281.6 mg KOH/g) and a water content of <0.1% by weight. This gives 127.0 g of N-butyl N-methyl-2-pyrrolidone-4-carboxylate.

### Example 4

### Preparation of methyl N-butyl-2-pyrrolidone-4-carboxylate

200.0 g of dimethyl itaconate (M=158.2 g/mol) are initially introduced and heated to 50° C. with stirring under a nitrogen atmosphere. Then, 92.4 g of n-butylamine (M=73.1 g/mol) are added dropwise over the course of 20 minutes, during which an exothermic reaction is observed. The reaction mixture is then brought to reflux temperature (95° C.) and stirred at reflux for 6 hours. The methanol present is then distilled off at 100 to 130° C. for 1 hour. The crude product is subjected to fractional distillation in vacuo.

The product passes over at a temperature of 131° C. at 2 to 3 mbar. The resulting product has a saponification number of 282.6 mg KOH/g (theory: 281.6 mg KOH/g) and a water content of <0.1% by weight. This gives 175.2 g of methyl N-butyl-2-pyrrolidone-4-carboxylate.

### Example 5

### Preparation of methyl N-isobutyl-2-pyrrolidone-4-carboxylate

200.0 g of dimethyl itaconate (M=158.2 g/mol) are initially introduced and heated to 50° C. with stirring under a nitrogen atmosphere. Then, 92.4 g of isobutylamine (M=73.1 g/mol) are added dropwise over the course of 20 minutes, during which an exothermic reaction is observed. Then, the reaction mixture is brought to reflux temperature (98° C.) and stirred at reflux for 5 hours. The methanol formed is then distilled off at 100 to 120° C. for 1 hour. The crude product is subjected to fractional distillation in vacuo. The product passes over at a temperature of 142-144° C. at 5 mbar. The resulting product has a saponification number of 282.6 mg KOH/g (theory: 281.6 mg KOH/g) and a water content of <0.1% by weight. This gives 170.9 g of methyl N-isobutyl-2-pyrrolidone-4-carboxylate.

### Example 6

### Determination of the VOC Content

The VOC content of methyl N-methyl-2-pyrrolidone-4-carboxylate from example 1 and isobutyl N-methyl-2-pyrrolidone-4-carboxylate from example 2 is determined by a gas chromatographic measurement in accordance with DIN EN ISO 11890-2. GC conditions: separating column: 15 m Stabilwax, 0.53 mm ID, 1.0 μm film thickness; injector: Split, split ratio 1:20; detector: FID; carrier gas: helium, 9 ml/min (40° C.), prepressure 22.4 kPa; detector gases: 350 ml/min synthetic air, 35 ml/min hydrogen, 21 ml/min helium (make-up gas); temperatures: injector: 250° C., detector: 280° C.; furnace: initial temperature: 40° C., holding time (isotherm): 3 min, heating rate: 25° C./min, end temperature: 260° C., holding time (isotherm): 5 min, injection volume: 2 pi; sample solution: ca. 1 g in 20 ml acetonitrile. Quantitative evaluation was carried out by means of calibration with an internal standard (isobutanol). Diethyl adipate (b.p. 251° C., Rₜ=8.8 min) was used as marker substances for the boiling point. All signals with a shorter retention time than diethyl adipate and also substances with a known boiling point <250° C. were evaluated. The VOC content is <0.2% by weight in both cases.

### Example 7

### Solubilities of Pesticides

The solubilities of various pesticides were determined in various compounds of formula (1) at 25° C. All data are in % by weight (Table 1).

TABLE 1
Solubilities of pesticides in compounds of formula (1)

| | | Pendi- | | | Tri- |
|---|---|---|---|---|---|
| Compound of formula | Triflu- | meth- | Tebucon- | Triad- | floxy- |
| (1) | ralin | alin | azole | imefon | strobin |
| Methyl N-methyl-2- | 55.3 | 23.3 | 39.3 | 45.2 | 30.7 |
| pyrrolidone-4- | | | | | |
| carboxylate from | | | | | |
| example 1 | | | | | |
| Isobutyl N-methyl-2- | 68.5 | 36.1 | 37.0 | 41.5 | 30.1 |
| pyrrolidone-4- | | | | | |
| carboxylate from | | | | | |
| example 2 | | | | | |
| N-butyl N-methyl-2- | 57.4 | 38.9 | 37.0 | 43.0 | 30.1 |
| pyrrolidone-4- | | | | | |
| carboxylate from | | | | | |
| example 3 | | | | | |
| Methyl N-butyl-2- | 58.6 | 38.9 | 38.2 | 43.0 | 31.1 |
| pyrrolidone-4- | | | | | |
| carboxylate from | | | | | |
| example 4 | | | | | |
| Methyl N-isobutyl-2- | 61.8 | 37.8 | 35.8 | 42.5 | 31.1 |
| pyrrolidone-4- | | | | | |
| carboxylate from | | | | | |
| example 5 | | | | | |

The result of the dissolution experiments shows that various, sparingly soluble pesticides with varying chemical structure are readily soluble in compounds of formula (1).

### Example 8

### Trifloxystrobin Formulation

A trifloxystrobin 125 EC formulation is prepared analogously to example 8 of WO 98/00009 A1, but replacing NMP with methyl N-methyl-2-pyrrolidone-4-carboxylate from example 1 (formulation 1).

| Formulation component | Amount [g] |
|---|---|
| Trifloxystrobin | 12.5 |
| Emulsogen ® EP 4901 | 12.5 |
| Emulsogen ® TS 160 | 10.0 |
| Dispersogen ® TP 160 | 2.5 |
| Methyl N-methyl-2-pyrrolidone-4-carboxylate | 62.5 |

External appearance of the formulation at 25° C., immediately: homogeneous, without crystals. External appearance of the formulation after storage for 14 days at 54° C.: homogeneous, without crystals.

### Example 9

### Tebuconazole Formulation A

A tebuconazole 200 EC formulation is prepared according to the following composition, using methyl N-methyl-2-pyrrolidone-4-carboxylate from example 1 (formulation 2).

| Formulation component | Amount [g] |
|---|---|
| Tebuconazole | 20.0 |
| Acetophenone | 20.0 |
| 2-Ethylhexanol | 20.0 |
| Methyl N-methyl-2-pyrrolidone-4-carboxylate | 10.0 |
| Emulsogen ® EP 4901 | 6.0 |
| Emulsogen ® TS 200 | 4.0 |
| Synergen ® KN | 20.0 |

External appearance of the formulation at 25° C., immediately: homogeneous, without crystals. External appearance of the formulation after storage for 14 days at 54° C.: homogeneous, without crystals.

### Example 10

### Tebuconazole Formulation B

A tebuconazole 200 EC formulation is prepared analogously to example 1 of EP 1 921 918 B1, replacing NMP with methyl N-methyl-2-pyrrolidone-4-carboxylate from example 1 (formulation 3).

| Formulation component | Amount [g] |
|---|---|
| Tebuconazole | 20.0 |
| Methyl caprylate | 35.0 |
| Methyl N-methyl-2-pyrrolidone-4-carboxylate | 16.0 |
| Octanol | 18.0 |
| Dispersogen ® LFH | 4.0 |
| Phenylsulfonate CA | 6.0 |

External appearance of the formulation at 25° C., immediately: homogeneous, without crystals. External appearance of the formulation after storage for 14 days at 54° C.: homogeneous, without crystals.

### Example 11

### Pendimethalin Formulation

A pendimethalin 330-EC formulation is prepared according to the following composition, using isobutyl N-methyl-2-pyrrolidone-4-carboxylate from example 2 (formulation 4).

| Formulation component | Amount [g] |
|---|---|
| Pendimethalin | 33.0 |
| Solvesso ® 150 | 42.0 |
| Isobutyl N-methyl-2-pyrrolidone-4-carboxylate | 15.0 |
| Phenylsulfonate CA | 5.0 |
| Emulsogen ® EL 400 | 5.0 |

External appearance of the formulation at 25° C., immediately: homogeneous, without crystals. External appearance of the formulation after storage for 14 days at 54° C.: homogeneous, without crystals.

### Example 12

### Triadimefon Formulation

A triadimefon 250-EC formulation is prepared according to the following composition, using methyl N-methyl-2-pyrrolidone-4-carboxylate from example 1 (formulation 5).

| Formulation component | Amount [g] |
|---|---|
| Triadimefon | 25.0 |
| Solvesso ® 150 | 35.0 |
| Methyl N-methyl-2-pyrrolidone-4-carboxylate | 30.0 |
| Phenylsulfonate CA | 5.0 |
| Emulsogen ® EL 360 | 5.0 |

External appearance of the formulation at 25° C., immediately: homogeneous, without crystals. External appearance of the formulation after storage for 14 days at 54° C.: homogeneous, without crystals.

### Example 13

### Triadimefon Formulation (Comparative Example)

A triadimefon 250-EC formulation is prepared analogously to example 12 but without methyl N-methyl-2-pyrrolidone-4-carboxylate from example 1.

| Formulation component | Amount [g] |
|---|---|
| Triadimefon | 25.0 |
| Solvesso ® 150 | 65.0 |
| Phenylsulfonate CA | 5.0 |
| Emulsogen ® EL 360 | 5.0 |

The EC formulation is initially homogeneous, but the active ingredient crystallizes out even upon standing at room temperature overnight. The formulation is not stable.

### Example 14

### Emulsion Quality

Emulsion tests were carried out using formulations 1 to 5 from examples 8 to 12. To form the emulsions, 95 parts by volume of water were initially introduced into a 100 ml measuring cylinder and 5 parts by volume of the emulsion concentrate (i.e. of formulations 1-5) were added and homogenized by inverting the closed measuring cylinder ten times. The results of the emulsion test are shown in Table 2.

TABLE 2
Emulsion tests with formulations 1-5 according to the invention

| | Water | Spontaneity | Separation | |
|---|---|---|---|---|
| Formu- | hardness | of emulsion | after 2 hours | Crystal- |
| lation | [ppm CaCO₃] | formation | [ml] | lization |
| 1 | 20 | good | 0 | none |
| | 342 | good | 0 | none |
| | 500 | good | 0 | none |
| 2 | 20 | good | 1 | none |
| | 342 | good | 1 | none |
| | 500 | good | 2 | none |
| 3 | 20 | good | 1 | none |
| | 342 | good | 1 | none |
| | 500 | good | 0.5 | none |
| 4 | 20 | good | 0 | none |
| | 342 | good | 5 | none |
| | 500 | good | 7 | none |
| 5 | 20 | good | 2 | none |
| | 342 | good | 2.5 | none |
| | 500 | good | 1 | none |

All formulations 1 to 5 spontaneously form good emulsions at different water hardnesses, these emulsions having no or no noteworthy separation even after two hours. In none of the cases is the crystallization of the active ingredient observed, which underlines the effect of the solvents as crystallization inhibitor.

1. A pesticide preparation comprising
a) at least one pesticide and
b) at least one N-substituted 2-pyrrolidone-4-carboxylic acid ester of the formula (1) 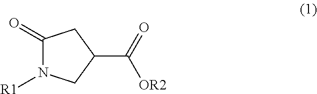
in which
R1 and R2 independently of one another are a linear, branched or cyclic C₁-C₆-alkyl.

2. The pesticide preparation as claimed in claim 1, wherein R1 and R2 in formula (1), independently of one another, are methyl, ethyl, n-propyl, isopropyl, n-butyl or isobutyl.

3. The pesticide preparation as claimed in claim 2, wherein, in formula (1)
R1 and R2 are methyl or
R1 is methyl and R2 is isobutyl or
R1 is n-butyl and R2 is methyl or
R1 is isobutyl and R2 is methyl.

4. The pesticide preparation as claimed in claim 1, wherein the VOC content of the compounds of the formula (1) in accordance with DIN EN ISO 11890-2 is less than 5% by weight.

5. The pesticide preparation as claimed in claim 1, wherein it is in the form of an emulsifiable concentrate (EC), an emulsion in water (EW), a soluble liquid (SL), a microemulsion (ME), a suspoemulsion (SE), a suspension concentrate (SC) or an oil dispersion (OD).

6. The pesticide preparation as claimed in claim 5, wherein it is an emulsifiable concentrate (EC).

7. The pesticide preparation as claimed in claim 5, wherein it is an emulsion in water (EW).

8. The pesticide preparation as claimed in claim 1, wherein the at least one compound of the formula (1) act as crystallization inhibitor.

9. The pesticide preparation as claimed in claim 1, wherein the solubility of the at least one or more pesticide of component a) in water at 20° C. is less than 1000 mg/l.

10. The pesticide preparation as claimed in claim 1, wherein the solubility of the at least one pesticide of component a) in the at least one or more compound of the formula (1) at 20° C. is at least 10 g/l.

11. The pesticide preparation as claimed in claim 1, wherein the at least one pesticide of component a) are selected from the group consisting of herbicides, insecticides and fungicides.

12. The pesticide preparation as claimed in claim 1, wherein it comprises the at least one pesticide of component a) in amounts of from 0.1 to 75% by weight, and the at least one compound of the formula (1) in amounts of from 0.1 to 99% by weight, in each case based on the total weight of the pesticide preparation.

13. The pesticide preparation as claimed in claim 1, wherein it further comprises, at least one auxiliary.

14. A method for controlling and/or combating weeds, fungal diseases or insect infestation comprising the step of contacting the weeds, fungus, or insects with a pesticide preparation as claimed in claim 1.
